(19) United States
(12) Patent Application Publication
(10) Pub. No.: US 2010/0138308 A1
(43) Pub. Date: Jun. 3, 2010

(54) BANKNOTE COUNTER AND BANKNOTE COUNTING SYSTEM

(76) Inventors: Yuichi Fujita, Hyogo (JP); Kazumi Yamauchi, Hyogo (JP); Shigekuni Sakiyama, Hyogo (JP); Toshiyuki Matsui, Hyogo (JP); Toru Takaki, Hyogo (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/452,622

(22) PCT Filed: Jul. 26, 2007
(86) PCT No.: PCT/JP2007/064691

§ 371 Date: Jan. 12, 2010

(51) Int. Cl. G06M 3/00; G06Q 40/00; G07F 7/04

(52) U.S. Cl. 705/16; 194/215

(57) ABSTRACT

There is provided a banknote counter 17 capable of speedily and accurately checking banknotes exchanged for chips and automatically acquiring and managing accurate transaction information. Banknotes received in the banknote counter 17 are recognized one by one by a recognition unit, and thus can be checked speedily and accurately compared with manually checking banknotes. Banknotes can be additionally received until one transaction is confirmed by a confirmation unit, and one transaction can be confirmed by the confirmation unit. Information on a confirmed transaction is displayed on an external display unit 18. Accurate information on a confirmed transaction is transmitted from the banknote counter 17 to a higher-ranking machine and can be automatically acquired and managed by the higher-ranking machine.

### TECHNICAL FIELD

The present invention relates to a banknote counter for counting banknotes exchanged for chips and a banknote counting system using the banknote counter.

### BACKGROUND ART

Chips are used in a table game played on a table in a casino or the like, and a system is adopted in which banknotes owned by a player can be exchanged for the chips by a dealer of the table game.

In a conventional exchange transaction of banknotes and chips on each table, a player hands banknotes to a dealer, and the dealer recognizes and checks the denomination and the number of received banknotes by eyesight and arranges the banknotes on the table. Further, the dealer can check, by ultraviolet irradiation in the case of authenticity of the arranged banknotes, whether each of the banknotes is a counterfeit banknote by use of an ultraviolet checking machine. When the banknotes are checked as genuine banknotes, the dealer hands chips of the kind and number corresponding to the checked amount to the player, and collects and drops the banknotes into a drop box on the table, with which the table is equipped, for storing banknotes (See, for example, Patent Documents 1 and 2).

Additionally, there are cases where transaction information on exchange of banknotes and chips on each table is managed for each transaction, and cases where transaction information is not managed. In the case where transaction information is managed for each transaction, a dealer or a specified person called a supervisor positioned at each table fills out the transaction information on a paper sheet for each transaction, and collects and manages the paper sheets, or manually inputs the transaction information into a terminal which is set up for each table and connected to a sales management unit for collectively managing transaction information manually input through the terminal.

Patent Document 1: Japanese Laid-Open Examined Utility Model No. 6-43083 (pages 1-2, FIG. 1)

Patent Document 2: Japanese Laid-Open Patent Publication No. 2005-92359 (page. 2)

### DISCLOSURE OF THE INVENTION

### Problems to be Solved by the Invention

However, since a dealer checks banknotes by eyesight at the time of transactions on a table, it is difficult to recognize a sophisticated counterfeit banknote, and still difficult to recognize a sophisticated counterfeit banknote even if an ultraviolet checking machine or the like is used. Therefore, banknotes cannot be accurately checked. Additionally, since it takes time to check banknotes and the progress of a game is hindered, it is difficult to increase sales for a predetermined time.

Further, in the case where transaction information for each table is managed, a dealer or a specified person fills out transaction information on a paper sheet for each transaction, and collects and manages the paper sheets, or manually inputs the transaction information into a terminal which is set up for each table and connected to a sales management unit for collectively managing transaction information manually input through the terminal. However, since he/she sometimes mistakenly fills out or forgets, to fill out transaction information on the paper sheets, or sometimes mistakenly inputs or forgets to input the information to the terminal, transaction information cannot be accurately managed, and finally, he/she is forced to collect and manage banknotes stored in a drop box on the table.

As described above, regarding an exchange transaction of banknotes and chips on a table in a casino or the like, accurate transaction information cannot be automatically acquired and managed.

The present invention has been made in view of the above problems, and it is an object of the present invention to provide a banknote counter capable of speedily and accurately checking banknotes exchanged for chips and automatically acquiring and managing accurate transaction information, and a banknote counting system capable of automatically acquiring and managing accurate transaction information with use of the banknote counter.

### Means to Solve the Problems

A banknote counter according to claim 1 of the present invention includes: a receiving unit for receiving banknotes for transactions; a transport unit for transporting banknotes received by the receiving unit one by one; a recognition unit for recognizing banknotes transported by the transport unit; a confirmation unit for issuing an instruction on confirmation of one transaction; a display unit for displaying transaction information; and a control unit for confirming transaction information based on an instruction from the confirmation unit and making the display unit display information regarding a recognition result by the recognition unit.

In a banknote counter according to claim 2 of the present invention, the banknote counter according to claim 1 includes a transmission unit for transmitting information on a transaction confirmed by the confirmation unit to a higher-ranking machine.

With a banknote counter according to claim 3 of the present invention, in the banknote counter according to claim 2, there is provided a canceling unit for canceling a transaction in the middle of the transaction, and the transmission unit transmits information on a transaction cancelled by the canceling unit to a higher-ranking machine.

In a banknote counter according to claim 4 of the present invention, the banknote counter according to any of claim 1 to claim 3 includes a reporting unit for reporting that a suspected counterfeit banknote is recognized by the recognition unit.

With a banknote counter according to claim 5 of the present invention, in the banknote counter according to any of claim 1 to claim 4, there are provided: a stacking unit for receiving and stacking banknotes each of which is recognized as a normal transaction banknote by the recognition unit and transported by the transport unit; and a rejection unit for receiving and stacking banknotes each of which is not recognized as a normal transaction banknote such as a suspected counterfeit banknote by the recognition unit and transported by the transport unit, and the control unit, when a suspected counterfeit banknote is recognized by the recognition unit, makes the display unit display which ordinal number of banknotes stacked in the rejection unit the suspected counterfeit banknote corresponds to.

With a banknote counter according to claim 6 of the present invention, in the banknote counter according to any of claim 1 to claim 5, there is provided a manual input unit for manually inputting information of a banknote to be included in one transaction, and the control unit causes banknote information, which is manually input with the manual input unit, to be included as information which can be recognized as manually input information, as at least a part of the transaction information.

With a banknote counter according to claim 7 of the present invention, in the banknote counter according to claim 6, there is provided a manual input possibility decision unit for deciding whether manually inputting with the manual input unit is allowed, and the control unit does not accept manually inputting with the manual input unit if the manual input possibility decision unit does not allow manual input.

With a banknote counter according to claim 8 of the present invention, in the banknote counter according to claim 2 or claim 3, there is provided a chip calculation unit for calculating an exchange content of chips exchangeable in accordance with a recognized amount, and the control unit causes the display unit to display a calculation result by the chip calculation unit and/or causes the transmission unit to transmit the calculation result to a higher-ranking machine.

A banknote counting system according to claim 9 of the present invention includes the banknote counter according to any of claim 1 to claim 8 and a sales management unit for communicating with the banknote counter and managing transaction information.

A banknote counting system according to claim 10 of the present invention includes the banknote counter according to any of claim 1 to claim 8 and a banknote counter management unit for communicating with the banknote counter and managing operation states of the banknote counter.

With a banknote counting system according to claim 11 of the present invention, in the banknote counting system according to claim 10, at least an occurrence state of a suspected counterfeit banknote is contained in an operation state to be managed by the banknote counter management unit.

A banknote counting system according to claim 12 of the present invention includes the banknote counter according to any of claim 1 to claim 8, a terminal communicatively connected to the banknote counter, and a sales management unit which communicates with the terminal and/or the banknote counter and manages transaction information.

### EFFECTS OF THE INVENTION

According to a banknote counter of claim 1 of the present invention, since received banknotes are recognized by a recognition unit, banknotes can be checked speedily and accurately compared with manually checking banknotes, banknotes can be additionally received until one transaction is confirmed by a confirmation unit, and one transaction can be confirmed by the confirmation unit, and therefore accurate transaction information can be automatically acquired and managed.

According to a banknote counter of claim 2 of the present invention, in addition to the effect of the banknote counter of claim 1, accurate information on a confirmed transaction is transmitted to and thus can be managed by a higher-ranking machine.

According to a banknote counter of claim 3 of the present invention, in addition to the effect of the banknote counter of claim 2, a transaction for illegal acquisition of banknotes can be prevented from being cancelled, for example, because, even if a transaction is cancelled in the middle of the transaction, information on the cancelled transaction is transmitted to a higher-ranking machine.

According to a banknote counter of claim 4 of the present invention, in addition to the effect of the banknote counter of any of claim 1 to claim 3, it can be reported that a suspected counterfeit banknote is recognized, and the counterfeit banknote can be prevented from being used.

According to a banknote counter of claim 5 of the present invention, in addition to the effect of the banknote counter of any of claim 1 to claim 4, a suspected counterfeit banknote can be specified in the case of being recognized, because a display unit displays which ordinal number of banknotes stacked in a rejection unit the suspected counterfeit banknote corresponds to, even if being stacked in the rejection unit together with other banknotes not recognized as normal transaction banknotes.

According to a banknote counter of claim 6 of the present invention, in addition to the effect of the banknote counter according to any of claim 1 to claim 5, in the case of a genuine banknote which the banknote counter has difficulty in recognizing, for example, a torn banknote, information on the torn banknote can be manually input with a manual input unit, and the manually input banknote information can be included as at least a part of the transaction information and can be included in the transaction information as information which can be recognized as manually input information.

According to a banknote counter of claim 7 of the present invention, in addition to the effect of the banknote counter according to claim 6, for example, the number of times that manual input is allowed or the number of times of continuation of manual input is limited, or only a specified person is allowed to manually input banknote information, and thus an illegal act can be prevented, because manually inputting with the manual input unit is not accepted if a manual input possibility decision unit does not allow manual input.

According to a banknote counter of claim 8 of the present invention, in addition to the effect of the banknote counter according to claim 2 or claim 3, an exchange content of chips exchangeable in accordance with a recognized amount can be calculated, a dealer is assisted and can be prevented from misunderstanding the exchange content of chips if a calculation result is displayed on the display unit, and exchange information on chips can be managed by a higher-ranking machine if the calculation result is transmitted to the higher-ranking machine.

According to a banknote counting system of claim 9 of the present invention, a sales management unit communicates with the banknote counter according to any of claim 1 to claim 8, and can automatically acquire and manage transaction information.

According to a banknote counting system of claim 10 of the present invention, a banknote counter management unit communicates with the banknote counter according to any of claim 1 to claim 8, and can manage operation states of the banknote counter.

According to a banknote counting system of claim 11 of the present invention, in addition to the effect of the banknote counting system of claim 10, at least an occurrence state of a suspected counterfeit banknote is contained in an operation state to be managed by the banknote counter management unit, and the frequency in occurrence of a suspected counterfeit banknote can be checked.

According to a banknote counting system of claim 12 of the present invention, the sales management unit communicates with the banknote counter according to any of claim 1 to claim 8 and/or a terminal made to communicate with the banknote counter, and which can manage transaction information.

### BRIEF DESCRIPTION OF THE DRAWINGS

FIG. 1 is a perspective view of a banknote counter in a use state according to an embodiment of the present invention.

FIG. 2 is a plan view showing arrangement of the banknote counter in use.

FIG. 3 is a side view showing an inner structure of the banknote counter.

FIG. 4 is a front view showing an operation unit and display unit of the banknote counter.

FIG. 5 is an explanatory view showing a display example by an external display unit of the banknote counter.

FIG. 6 is an explanatory view showing another display example by the external display unit of the banknote counter.

FIG. 7 is an explanatory view showing still another display example by the external display unit of the banknote counter.

FIG. 8 is a block diagram of the banknote counter.

FIG. 9 is a structural diagram of a banknote counting system using the banknote counter.

FIG. 10 is a structural diagram of a banknote counting system using a banknote counter according to another embodiment of the present invention.

### REFERENCE NUMERALS

17: Banknote counter
18: External display unit as display unit
19: State display unit as reporting unit
20: Terminal
28: Receiving unit
29: Rejection unit
30: Stacking unit
37: Transport mechanism as transport unit
39: Recognition unit
48: Confirmation button as confirmation unit
52: Clear button as canceling unit
54: Manual input unit
66: Control unit
70: Second communication unit as transmission unit
71: Banknote counter management unit
72: Sales management unit

### BEST MODES FOR CARRYING OUT THE INVENTION

Hereinafter, embodiments of the present invention will be described with reference to the drawings.

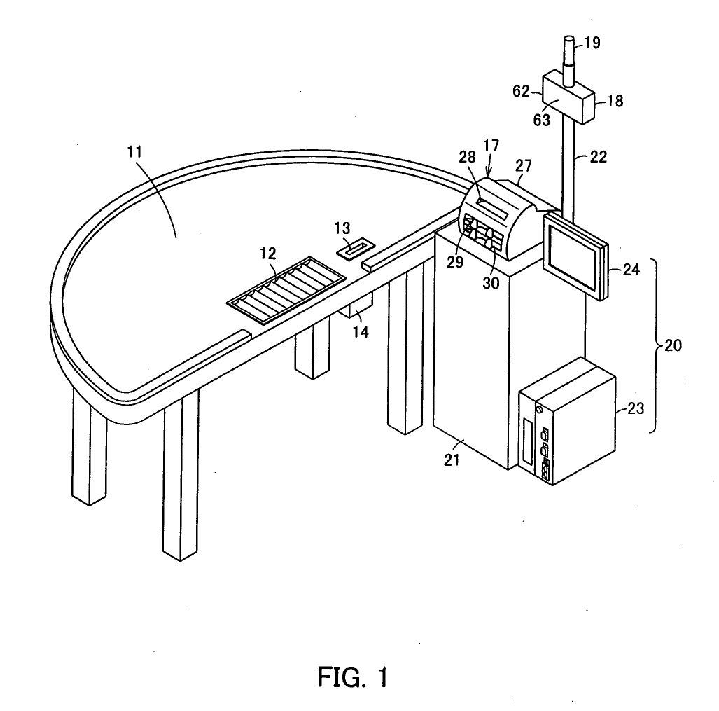

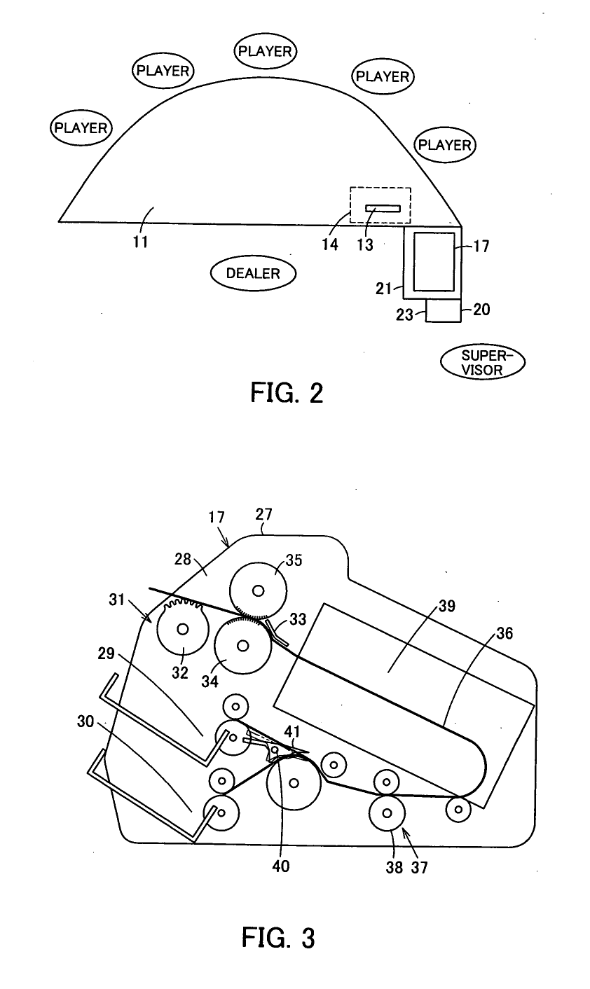

In FIGS. 1 and 2, the reference numeral 11 denotes an approximately semicircular table for playing table games in a casino or the like. A dealer for table games and a supervisor, which is a manager positioned for each or a plurality of table(s) 11, are placed along the a straight line edge side of the table 11, and a plurality of players playing table games are placed along the curved line edge side of the table 11. Chips are used for table games, and can be exchanged for banknotes owned by the players through the dealer.

In the vicinity of the straight line edge side of the table 11, there are provided: a chip holder 12 in which a plurality of chips are put; a banknote inlet 13 in which banknotes exchanged for chips are put by the dealer; a drop box 14 for storing banknotes put in through the banknote inlet 13; and the like.

On one side of the straight line edge side of the table 11, there are provided: a banknote counter 17 for recognizing and counting banknotes exchanged for chips; an external display unit 18 as a display unit which is connected to the banknote counter 17 to display various information; a state display unit 19 as a reporting unit for displaying states of the banknote counter 17; and a terminal 20 that is communicatively connected to the banknote counter 17. The banknote counter 17 is mounted on a trestle 21 having approximately the same height as that of an upper face of the table 11, and a pole 22, to which the external display unit 18 and state display unit 19 are attached, is erected on the trestle 21.

The terminal 20 includes: a terminal body 23 consisting of a personal computer, etc.; and a monitor 24 connected to the terminal body 23. The monitor 24 has a touch panel and functions as an operation unit. The terminal body 23 is arranged on the side of the trestle 21, and the monitor 24 is arranged on the upper side of the trestle 21 so as to be easily viewed and operated.

Next, FIG. 3 shows an inner structure of the banknote counter 17.

The banknote counter 17 has a casing 27. In the front of the casing 27, there are provided in order from the upper side to the lower side: a receiving unit 28 for receiving banknotes to be recognized and counted by the banknote counter 17; a rejection unit 29 to which banknotes not recognized as normal transaction banknotes by the banknote counter 17 are sent; and a stacking unit 30 to which banknotes recognized as normal transaction banknotes are sent. Banknotes sent to the rejection unit 29 and stacking unit 30 can be taken out. A banknote having a kind different from that for transactions, an unrecognizable banknote such as a torn banknote, a suspected counterfeit banknote and the like are cited as a banknote which is not recognized as a normal transaction banknote sent to the rejection unit 29. Additionally, all banknotes, which are recognized as normal transaction banknotes sent to the stacking unit 30, correspond to genuine banknotes of a kind for transactions. A plurality of banknotes can be received, in a stacked state, by the receiving unit 28, rejection unit 29 and stacking unit 30, respectively. For example, one hundred banknotes can be received by the receiving unit 28 at maximum, and thirty banknotes can be respectively stacked and stored in the rejection unit 29 and also the stacking unit 30 at maximum, which is the upper limit value.

A feeding mechanism 31 for separating and feeding banknotes one by one into the casing 27 is disposed in the receiving unit 28. The feeding mechanism 31 includes: a feeding roller 32 which contacts and feeds banknotes placed at the lowermost portion of the receiving unit 28; a sending roller 34 which holds a banknote fed from the feeding roller 32 between the roller 34 and a sending guide 33 and sends the banknote into the casing 27; and a reverse rotating roller 35 which reversely rotates in a feeding direction to regulate movement of banknotes, which are placed on a banknote placed at the lowermost portion of the receiving unit 28, in the feeding direction.

In the casing 27, a transport path 36 is formed from the receiving unit 28 to the rejection unit 29 or stacking unit 30. A transport mechanism 37 as a transport unit for transporting banknotes, which are fed one by one into the transport path 36 by the feeding mechanism 31 of the receiving unit 28, to the rejection unit 29 or stacking unit 30 is disposed on the transport path 36. Specifically, a plurality of transport rollers 38 of the transport mechanism 37 are disposed.

A recognition unit 39 for recognizing banknotes is disposed in the middle of the transport path 36. A plurality of kinds of recognition sensors are used for the recognition unit 39, the recognition unit 39 includes a recognizing portion for recognizing the authenticity of a banknote and a counting portion for counting banknotes recognized as genuine banknotes by denomination, and there can be recognized; a genuine banknote of a kind for transactions; a banknote having a kind different from that for transactions; an unrecognizable banknote such as a torn banknote; a suspected counterfeit banknote; etc.

A diverter 40 for switching and diverting a transporting direction of banknotes to the rejection unit 29 or stacking unit 30 in accordance with a recognition result by the recognition unit 39 is disposed at the downstream side, in relation to the recognition unit 39, of the transport path 36 in the transporting direction. The diverter 40 includes a diversion piece 41 arranged at a diversion point of the transport path 36 and a diversion drive unit such as a solenoid or motor for subjecting the diversion piece 41 to switching operation.

Existence detection sensors for detecting whether banknotes exist are provided in the receiving unit 28, rejection unit 29 and stacking unit 30, respectively, a feed detection sensor for detecting banknotes fed by the feeding mechanism 31 is provided at a starting end of the transport path 36, and a plurality of transport detection sensors for detecting banknotes in the transport path 36 are provided at a plurality of places of the transport path 36.

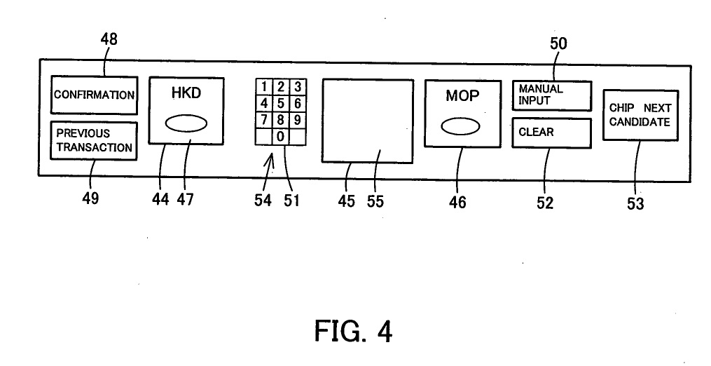

Next, FIG. 4 shows an operation unit 44 and display unit 45 which are provided on a front face or upper face of the banknote counter 17.

The operation unit 44 includes: a MOP button 46 and an HKD button 47 as a transaction banknote kind setting unit; a confirmation button 48 as a confirmation unit for issuing an instruction on confirmation of one transaction; a previous transaction button 49 for displaying contents of the previous transaction; a manual input button 50 for issuing an instruction on manually inputting banknote information; a numeric keypad 51 for inputting an ID and a password and manually inputting banknote information; a clear button 52 for clearing input; and a chip next candidate button 53 for displaying the next candidate of a distribution pattern of the kind and number of chips for exchange.

The banknote counter 17 of this example is formed so as to be used in a casino in Macau in which two kinds of banknotes, the Macau pataca and the Hong Kong dollar, are in circulation, and includes the MOP button 46 for setting a transaction using the Macau pataca, and the HKD button 47 for setting a transaction using the Hong Kong dollar. Moreover, no button for setting the kind of banknote is required in a place where only one kind of banknote is in circulation.

The manual input button 50 and numeric keypad 51 function as a manual input unit 54 for manually inputting banknote information so that, for example, unrecognizable banknotes are included in one transaction. Additionally, the clear button 52 functions as a canceling unit for canceling a transaction in the middle of the transaction.

Additionally, the display unit 45 includes a body display unit 55 such as, for example, a liquid crystal display for displaying various items including transaction contents, etc. Further, light sources such as an LED are arranged which at least respectively display, by lighting, that the MOP button 46 and HKD button 47 are selected, and each functions as a part of the display unit 45.

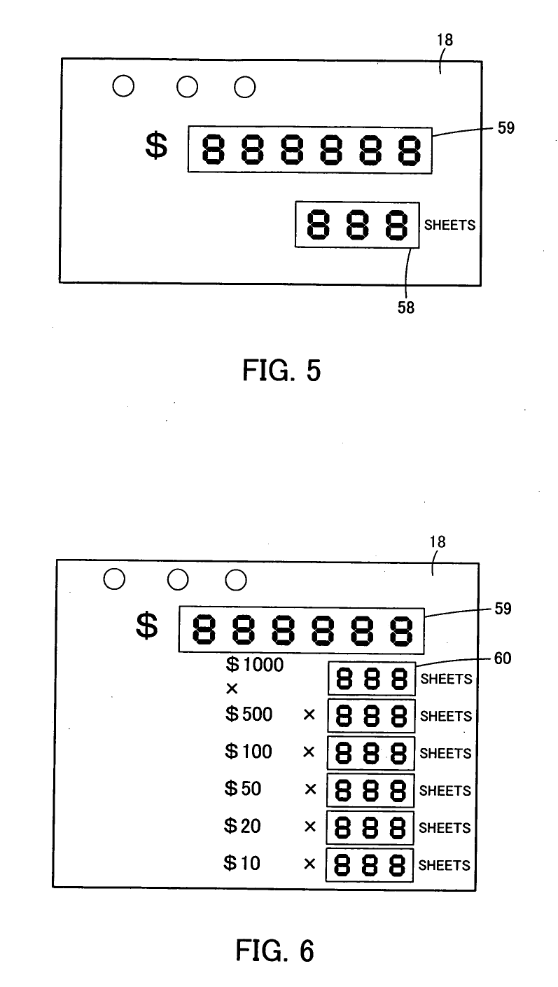

Next, FIGS. 5 to 7 show various display examples displayed on the external display unit 18 of the banknote counter 17.

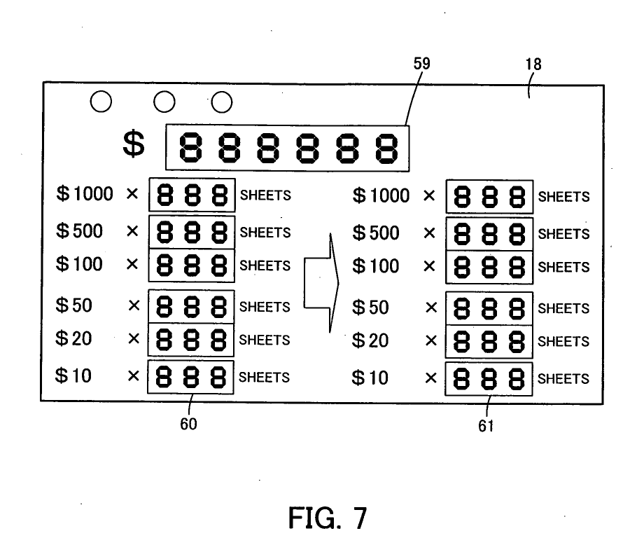

In the display example shown in FIG. 5, there are provided: a number display unit 58 for displaying the number of counted banknotes; and a total amount display unit 59 for displaying the total amount. In the display example shown in FIG. 6, there are provided: a denomination-specific deposited number display unit 60 for displaying the counted number of banknotes by denomination; and the total amount display unit 59 for displaying the total amount. In the display example shown in FIG. 7, there are provided: the denomination-specific deposited number display unit 60 for displaying the number of counted banknotes by denomination; the total amount display unit 59 for displaying the total amount; and a chip exchange number display unit 61 for displaying a distribution pattern of the kind and number of chips for exchange. Any of the display examples may be adopted, or switching may be arbitrarily made between the display examples by making the display examples switchable between them.

As shown in FIG. 1, the external display unit 18 includes an external display unit body 62 supported by the pole 22, and display face (s) 63 are provided at one side or both sides of the external display unit body 62. In the case where the display face 63 is provided at only one side of the external display unit body 62, the external display unit 18 is arranged in a place where both a dealer and players can visually check the display face 63. In the case where the display faces 63 are provided at both the sides of the external display unit body 62, the external display unit 18 is arranged in a place where a dealer can visually check one of the display faces 63 and players can visually check the other display face 63. Moreover, contents displayed on the external display unit 18 can be visually checked by not only a dealer and players but also a supervisor and a clerk positioned away from the table, and are easily reflected in video of monitoring cameras arranged in a game room.

Additionally, for example, a multi-LED as a light source is used for the state display unit 19 arranged above the external display unit 18, and the state display unit 19 can perform lighting display with use of arbitrary emission color.

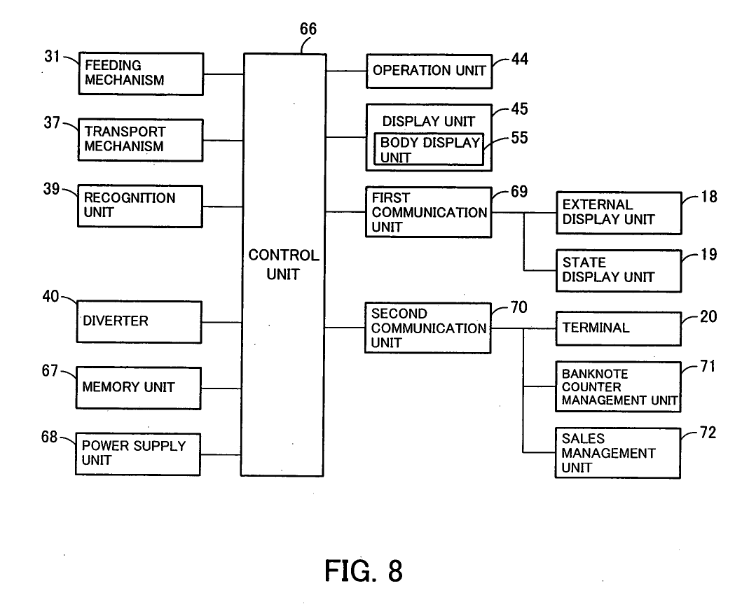

Next, FIG. 8 is a block diagram illustrating the constitution of the banknote counter 17.

The banknote counter 17 includes a control unit 66 for controlling not only the banknote counter 17 itself but also the external display unit 18 and state display unit 19. To the control unit 66, there are connected: the feeding mechanism 31; the transport mechanism 37; the recognition unit 39; the diverter 40; a memory unit 67 for storing various set contents, transaction contents, etc.; a power supply unit 68 for supplying power to each unit of the banknote counter 17; the operation unit 44; the body display unit 55; a first communication unit 69; and a second communication unit 70 as a transmission unit.

The first communication unit 69 is communicatively connected to the external display unit 18 and the state display unit 19.

The second communication unit 70 is communicatively connected to the terminal 20, a banknote counter management unit 71 and a sales management unit 72, the units 71 and 72 each being a higher-ranking machine.

The control unit 66 has the following functions. Moreover, the following functions are some of the functions which the control unit 66 has.

One transaction is confirmed by the confirmation button 48, and the external display unit 18 is made to display information on the confirmed transaction and information regarding a recognition result by the recognition unit 39.

Information on a transaction confirmed by the confirmation button 48 and information on a transaction cancelled by the clear button 52 are transmitted to the banknote counter management unit 71 and sales management unit 72 as higher-ranking machines through the second communication unit 70.

When a banknote is recognized as a suspected counterfeit banknote by the recognition unit 39, this is reported by making the state display unit 19 turn on, or reported to external units such as the banknote counter management unit 71, terminal 20 and sales management unit 72 through the second communication unit 70.

When a banknote is recognized as a suspected counterfeit banknote by the recognition unit 39, the body display unit 55, external display unit 18 or monitor 24 is made to display which ordinal number of banknotes stacked in the rejection unit 29 the suspected counterfeit banknote corresponds to.

Banknote information manually input through the manual input button 50 and numeric keypad 51 can be recognized as manually input information, and is included as at least a part of the transaction information.

There is provided a manual input possibility decision unit for deciding whether manual input is allowed, and manually inputting with the manual input unit is not accepted if the manual input possibility decision unit does not allow manual input. The manual input possibility decision unit allows manual input when the number of times of manual input or the number of times of continuation of manual input in a predetermined period (for example, a predetermined time preset, or a period from change of a dealer) is smaller than a predetermined number of times, and does not allow manual input when being larger than the predetermined number of times. Additionally, the manual input possibility decision unit allows only a specified person, who inputs a specified ID and password, manual input, and does not allow a person other than the specified person manual input.

There is provided a chip calculation unit for calculating an exchange content of chips exchangeable in accordance with a confirmed amount, that is, a distribution pattern of the kind and number of chips for exchange. The external display unit 18 is made to display a calculation result by the chip calculation unit as shown in FIG. 7, or the calculation result is transmitted to the banknote counter management unit 71 and sales management unit 72 as higher-ranking machines through the second communication unit 70.

There is provided an interface function of communicating with the terminal 20. In the interface function, at the end of a transaction, notification of transaction completion or cancellation is transmitted to the terminal 20, notification of reception completion is received from the terminal 20, and then the next transaction can be performed. If a time-out is caused after a plurality of times of retry in the case where an unsuccessful transmission to the terminal 20 is caused in transmission, the transmission to the terminal 20 is temporarily stopped, untransmitted data is stored in the memory unit 67, and the next transaction is awaited. In retention of untransmitted data, a communication state with the terminal 20 is checked before the end of a transaction, untransmitted data is transmitted in the order of older data if communication is possible.

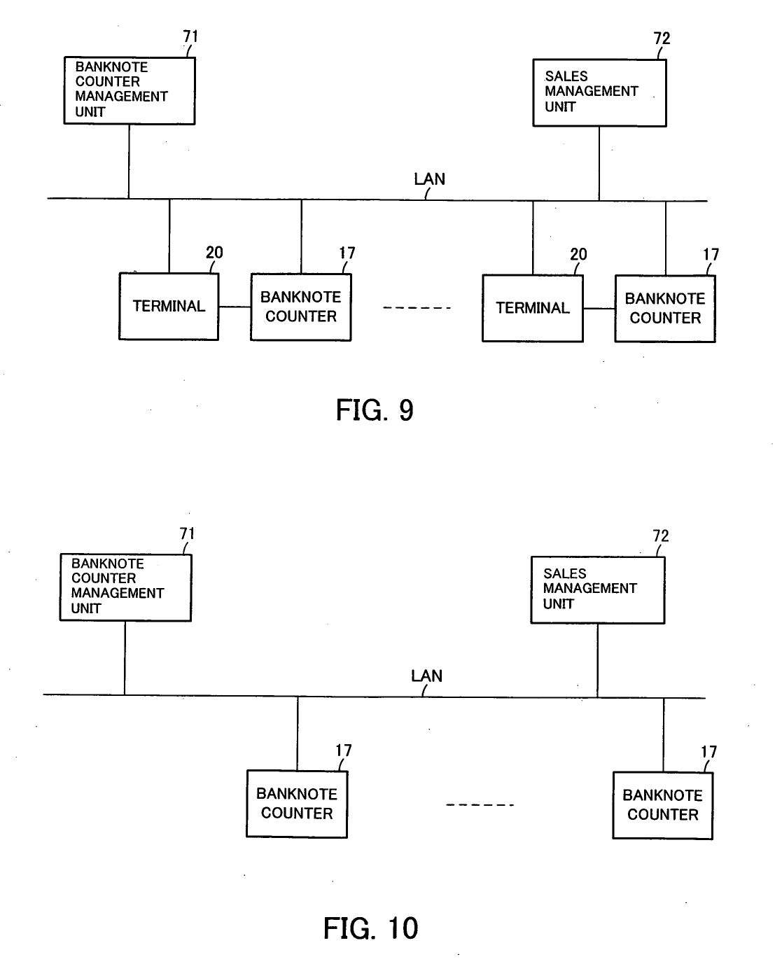

Next, FIG. 9 shows a banknote counting system adopted in a casino.

The banknote counters 17 and terminals 20 of a plurality of tables 11 set up in a casino are respectively connected to each other through a LAN, and one banknote counter management unit 71 and one sales management unit 72 are connected to the LAN.

The terminal 20 communicates with the banknote counter 17 to transmit transaction information of the banknote counter 17 to the sales management unit 72.

The banknote counter management unit 71 monitors an operation state of each banknote counter 17 in real time to find a malfunctioning banknote counter 17, and acquires information on recognition results of banknotes from each banknote counter 17 to collect and analyze various information such as banknote recognition rate information and banknote kind-specific counterfeit banknote information. Further, the banknote counter management unit 71 performs version management of programs, version upgrade, alert display in connection of a banknote counter 17 having a different version, and automatic version adjustment regarding the recognition unit 39 and control unit 66 of each banknote counter 17. Furthermore, the banknote counter management unit 71 collectively sets various setting items on each group of grouped banknote counters 17 and all the banknote counters 17, finds an abnormal set value for each group and outputs a report thereof, and also finds a banknote counter 17, to which suspected illegal operation such as cancellation is frequently performed, and outputs a report thereof.

The sales management unit 72 acquires transaction information on each banknote counter 17 to manage sales.

Moreover, when transaction information cannot be transmitted from the banknote counter 17 to the terminal 20, the transaction information is transmitted from the banknote counter 17 to the banknote counter management unit 71, and may be transmitted from the banknote counter management unit 71 to the sales management unit 72.

Next, actions of the present embodiment will be described.

In an exchange transaction of banknotes and chips on each table 11, a player hands banknotes to a dealer, the dealer checks the kind of received banknotes and selects the MOP button 46 or HKD button 47 of the banknote counter 17 to set banknotes to the receiving unit 28 of the banknote counter 17. When banknotes are set to the receiving unit 28, the existence detection sensor of the receiving unit 28 detects banknotes, the feeding mechanism 31 and transport mechanism 37 are operated, and counting operation is automatically started. Thus, the banknotes in the receiving unit 28 are separated one by one, fed to the transport path 36 and transported in the transport path 36.

The light source such as an LED of one selected from the MOP button 46 and HKD button 47 turns on and displays a selected banknote kind. The banknote kind set in the previous transaction is also maintained in the next transaction. When banknotes of the same kind are also used in the next transaction, selection of the MOP button 46 or HKD button 47 is not required, and counting operation is automatically started only by setting banknotes to the receiving unit 28.

Moreover, counting operation may be started by selecting the MOP button 46 or HKD button 47 after banknotes are set to the receiving unit 28.

Banknotes, which are transported in the transport path 36 and recognized as banknotes of a kind for genuine transactions and as normal transaction banknotes by the recognition unit 39, are transported, stacked and stored in the stacking unit 30 via the diverter 40. The counted result is displayed on the external display unit 18.

Banknotes, each which is not recognized as a normal transaction banknote such as a banknote having a kind different from that for transactions, an unrecognizable banknote such as a torn banknote, and a suspected counterfeit banknote by the recognition unit 39, are transported, stacked and stored in the rejection unit 29 via the diverter 40.

Even if all banknotes in the receiving unit 28 are fed and stored in the stacking unit 30 or rejection unit 29, banknotes can be additionally put in the receiving unit 28 in the current transaction until a dealer operates the confirmation button 48.

Additionally, during counting operation, although successively feeding banknotes from the receiving unit 28 to the transport path 36 and simultaneously transporting in the transport path 36, the control unit 66 causes the receiving unit 28 to stop feeding banknotes when the 29th (the ordinal number corresponds to a value slightly smaller than an upper limit value of the number of banknotes storable in the stacking unit 30, for example, a value smaller than that by one) normal transaction banknote is recognized by the recognition unit 39. Although a banknote following the 29th banknote has already been fed from the receiving unit 28 to the transport path 36 at this time, a further following banknote is not fed. Since the banknote following the 29th banknote is also transported, stacked and stored in the stacking unit 30 when being recognized as a normal transaction banknote, 30 (exact upper limit value) banknotes are stacked and stored in the stacking unit 30 and the counting operation is temporarily stopped in this state.

When the banknote following the 29th banknote is not recognized as a normal transaction banknote and transported to the rejection unit 29, only one banknote is additionally fed from the receiving unit 28. The additionally fed banknote is transported, stacked and stored in the stacking unit 30 when being recognized as a normal transaction banknote, or transported, stacked and stored in the rejection unit 29 when not being recognized as a normal transaction banknote. Banknotes are thus fed one by one from the receiving unit 28 after recognition of banknotes, and thus 30 (exact upper limit value) banknotes are stacked and stored in the stacking unit 30.

When the number of banknotes stacked and stored in the stacking unit 30 thus reaches the upper limit value in the middle of counting operation and then the counting operation is temporarily stopped, a dealer takes banknotes off from the stacking unit 30. The existence detection sensor of the stacking unit 30 then detects no banknote, and thus the counting operation is automatically restarted.

In the case where there are no suspected counterfeit banknotes but there are many banknotes not recognized as normal transaction banknotes such as unrecognizable banknotes as banknotes each having a kind difference from that for transactions and torn banknotes, the rejection unit 29 sometimes becomes full. In this case, the control unit 66 causes the receiving unit 28 to stop feeding banknotes when, for example, the 30th (the ordinal number corresponds to the upper limit value of the number of banknotes storable in the rejection unit 29) banknote is not recognized as a normal transaction banknote by the recognition unit 39. Thus, the 30th banknote not recognized as a normal transaction banknote is transported, stacked and stored in the rejection unit 29.

Although a banknote following the 30th banknote has been already fed from the receiving unit 28 to the transport path 36, a further following banknote is not fed. The banknote following the 30th banknote is transported, stacked and stored in the stacking unit 30 when being recognized as a normal transaction banknote, or transported, stacked and stored in the rejection unit 29 when not being recognized as a normal transaction banknote, and counting operation is temporarily stopped in this state. Although the banknotes larger than the upper limit value, 30, by one are thus stacked and stored in the rejection unit 29, there is no problem.

When the number of banknotes stacked and stored in the rejection unit 29 thus reaches the upper limit value in the middle of counting operation and then the counting operation is temporarily stopped, a dealer takes banknotes off from the rejection unit 29. The existence detection sensor of the rejection unit 29 then detects no banknote, and thus the counting operation is automatically restarted.

Moreover, control in the case where the rejection unit 29 reaches the upper limit value may be performed similar to that in the case where the stacking unit 30 reaches the upper limit value. However, since banknotes are fed one by one from the receiving unit 28 after recognition of banknotes until a banknote is not recognized as a normal transaction banknote, the counting speed is lowered, thereby being unsuitable for counting a great number of banknotes.

Additionally, when a suspected counterfeit banknote is recognized during counting operation, at first, this is reported by turning-on of the state display unit 19 or reported to external units such as the banknote counter management unit 71, terminal 20 and sales management unit 72 from the banknote counter 17. When recognition of a suspected counterfeit banknote is reported by turning-on of the state display unit 19, a dealer or supervisor can know this, and a player, who has handed over banknotes, can have some understanding of this. When the recognition of a suspected counterfeit banknote is reported to the external units, the banknote counter management unit 71 and sales management unit 72 alert-displays this, and a monitor or the like waiting in an office provided with these units knows this and is allowed to photograph the periphery of the corresponding table 11 with a monitoring camera or make a report on this.

Even if a suspected counterfeit banknote is recognized, counting operation is continued until all banknotes in the receiving unit 28 are fed and the counting operation is stopped, or the stacking unit 30 or rejection unit 29 reaches the upper limit value and the counting operation is stopped.

When, after a suspected counterfeit banknote is recognized, all banknotes in the receiving unit 28 are fed and counting operation is stopped, or the stacking unit 30 or rejection unit 29 reaches the upper limit value and the counting operation is stopped, the body display unit 55, external display unit 18 or monitor 24 displays which ordinal number from the top (or from the bottom) of banknotes stacked in the rejection unit 29 the suspected counterfeit banknote corresponds to. In the case where there exists a plurality of suspected counterfeit banknotes, all of the banknotes are displayed.

A dealer or supervisor, who has checked displayed contents, pulls out and checks only a suspected counterfeit banknote (s) from banknotes taken out from the rejection unit 29.

Moreover, it is possible to arbitrarily set whether the state display unit 19 displays that a suspected counterfeit banknote is recognized. In the case where the state display unit 19 displays that, color and lighting mode can be set distinctly from those set in displaying another state. Regardless of the presence/absence of displaying of the state display unit 19, it is reported to the external units that a suspected counterfeit banknote is recognized.

Additionally, among banknotes sent into the rejection unit 29, except a suspected counterfeit banknote and a banknote having a kind different from that for transactions, a banknote not recognized as a normal banknote such as a torn banknote can be handled in one transaction by manual input if determined to be a genuine banknote by a supervisor checking the abnormal banknote.

In the manual input, the supervisor operates the manual input button 50, inputs a specified ID and password for getting permission of manually inputting with the numeric keypad 51, manually inputs the denominations and the number of banknotes with the numeric keypad 51 after the permission of manually inputting, and operates the confirmation button 48. The body display unit 55 here displays input contents of manual input operation. Moreover, in the operation of the confirmation button 48 at this time, manual input is confirmed but no transaction is confirmed. During manual input, this state is displayed by the state display unit 19 or the like. Additionally, when the denominations and the number of banknotes are manually input, by providing a banknote button by denomination on the operation unit 44 in advance, the denominations and the number of banknotes can be easily manually input only by operating the corresponding banknote button by the number of times corresponding to the number of banknotes by denomination. Moreover, the operation of the manual input can also be performed in the terminal 20.

Before confirmation of manual input by operation of the confirmation button 48, transaction information by manual input can be included in the transaction information recognized by the banknote counter 17. However, the transaction information by manual input should be recognizable.

After confirmation of manual input by operation of the confirmation button 48, banknote information manually input is managed in another transaction. However, in the case where only transaction information recognized by the banknote counter 17 is included and no transaction information by manual input is included in information on the previous transaction even after the confirmation by operation of the confirmation button 48, the transaction information by manual input can be included in the transaction information on the previous transaction, according to the above-described manual input operation, by operating the previous transaction button 49 to call up the transaction information on the previous transaction.

The manual input is restricted by a supervisor inputting a specified ID and password, etc. Further, an illegal act can be more reliably prevented by, for example, restricting the number of times that manual input is allowed or restricting the number of times of continuation in the case where manual input is continued.

Additionally, in the middle of a transaction before confirmation, a dealer can cancel the transaction by operating the clear button 52. Information on the cancelled transaction is transmitted to the sales management unit 72 as a higher-ranking machine, and cancellation for illegal acquisition of banknotes by a dealer can be prevented. It is because there is a possibility that, for example, a dealer, after completion of counting, performs not confirmation operation but cancellation operation, and illegally acquires banknotes without putting them in the drop box 14 although handing chips to a player. Cancellation is reported to a supervisor or the like in a manner that lighting display is performed by the state display unit 19 in color and lighting mode corresponding to cancellation at the time of cancellation.

Additionally, when counting operation of the banknote counter 17 ends, a dealer operates the confirmation button 48, and thus a transaction is confirmed, and information on the confirmed transaction and information regarding a recognition result by the recognition unit 39 are displayed on the external display unit 18 and transmitted to the sales management unit 72. In this confirmation, the state display unit 19 performs lighting display by color and lighting mode corresponding to confirmation so that the confirmation of the transaction is reported to a supervisor etc.

A dealer informs a player of transaction information displayed on the external display unit 18 and pays out chips of the kind and number corresponding to a confirmed amount by approval of the player to the player, and banknotes are stored in the drop box 14 through the banknote inlet 13.

At this time, a distribution pattern of the kind and number of chips exchangeable in accordance with the confirmed amount is calculated by a function of a chip calculation unit of the control unit 66. The calculation result can be displayed on the external display unit 18 as shown in FIG. 7.

Specifically, the banknote counter 17 includes an exchange-unit memory unit for storing an exchange unit of banknotes and chips to calculate a distribution pattern of the kind and number of optimal chips based on a confirmed amount. When a basic exchange unit is set to 5 dollars, for example, the number of 5 dollar chips is calculated at 20 chips in the case of receiving 100 dollars and this result is displayed. Additionally, when a basic exchange unit is set to 25 dollars, for example, the number of 25 dollar chips is calculated at 4 chips in the case of receiving 100 dollars and this result is displayed.

Since a distribution pattern of the kind and number of optimal chips based on a confirmed amount is thus calculated and displayed, a dealer is assisted and any mistake of an exchange content of chips and a trouble between the dealer and a player can be prevented.

A calculation result of a distribution pattern of the kind and number of chips is automatically transmitted to the sales management unit 72 as a higher-ranking machine, and exchange information of chips can be managed by the sales management unit 72.

Further, when a displayed distribution pattern of the kind and number of chips is undesirable by the will of a player or the strategy of a game, switching to another distribution pattern of the kind and number of chips can be made and the pattern can be displayed, by operating the chip next candidate button 53. For example, although a 5 dollar chip corresponds to a basic exchange unit in a table 11 in which the lowest rate is 5 dollars, a 25 dollar chip is handled as a basic exchange unit if a player wishes to play a game in a unit of 25 dollars. Even if a basic exchange unit is thus changed from 5 dollars to 25 dollars, display switching is made by operation of the chip next candidate button 53 and it is possible to easily cope with such switching.

Moreover, limited to Macau, a bet line called “ANY PAIR” is set for Black Jack, and there exists a rule that chips can be obtained at odds of 11-1 in the case where handed out cards are paired with each other in betting chips on “ANY PAIR.” Since an amount of money bet on “ANY PAIR” is handled as half of an amount of generally bet money, money of 50 dollars is necessary in the case where 100 dollars is set as a basic exchange unit. Accordingly, even in the case where banknotes are generally exchanged for 100 dollar chips, a player frequently betting chips on “ANY PAIR” usually exchanges banknotes for chips including 50 dollar chips. Even in such a case, display switching is made by operation of the chip next candidate button 53 and it is possible to easily cope with the case.

Additionally, by not only displaying the kind and number of exchanged chips with the external display unit 18 but also storing and adding up data on the kind and number of exchanged chips, a use state and necessary number of chips for each kind are checked, and demand forecast such as an exchange opportunity of chips as a result of wear can be performed.

Additionally, transaction information of the previous transaction is displayed on the external display unit 18 and body display unit 55 by operating the previous transaction button 49. Only transaction information of the previous transaction is displayed on the external display unit 18 for, for example, confirmation according to a request from a player. The body display unit 55 displays the kind, number, total amount and specification of processing of banknotes, and further the transaction in order from the newest one for every operation of the previous transaction button 49 is displayed, so that the contents of the previous transactions can be checked.

Since received banknotes are thus recognized by the recognition unit 39 in the banknote counter 17, banknotes can be checked speedily and accurately compared with manually checking banknotes, banknotes can be additionally received until one transaction is confirmed by the confirmation button 48, and one transaction can be confirmed by the confirmation button 48.

Since information on a confirmed transaction is transmitted to the sales management unit 72 as a higher-ranking machine, the sales management unit 72 can automatically acquire and manage accurate transaction information.

The banknote counter management unit 71 can manage an operation state of each banknote counter 17 as described above. Specifically, the banknote counter management unit 71 monitors an operation state of each banknote counter 17 in real time to find a malfunctioning banknote counter 17. Additionally, the banknote counter management unit 71 acquires information from each banknote counter 17 to collect and analyze various information such as recognition rate information of banknotes and banknote-kind-specific counterfeit banknote information. The banknote counter management unit 71, for example, checks an occurrence state of a suspected counterfeit banknote, collects and analyzes the occurrence frequency of a suspected counterfeit banknote, etc., finds a banknote counter 17, in which operation having a possibility of an illegal act such as cancellation is frequently performed, and outputs a report. Further, the banknote counter management unit 71 is provided with functions of collectively making versions of programs of the banknote counters 17 upgrade and manage versions.

Moreover, as shown in FIG. 10, information may be transmitted from each banknote counter 17 to the banknote counter management unit 71 and sales management unit 72 by omitting the terminal 20.

Additionally, the banknote counter 17 may be formed as a tabletop type so as to be mounted on the table 11.

### INDUSTRIAL APPLICABILITY

The present invention is applied to a banknote counter on a table on which a table game is played, and to a banknote counter for exchanging banknotes for chips in places other than a place where a table is located.

1. A banknote counter comprising:
a receiving unit for receiving banknotes for transactions;
a transport unit for transporting banknotes received by the receiving unit one by one;
a recognition unit for recognizing banknotes transported by the transport unit;
a confirmation unit for issuing an instruction on confirmation of one transaction;
a display unit for displaying transaction information; and
a control unit for confirming transaction information based on an instruction from the confirmation unit and making the display unit display information regarding a recognition result by the recognition unit.

2. The banknote counter according to claim 1, comprising a transmission unit for transmitting information on a transaction confirmed by the confirmation unit to a higher-ranking machine.

3. The banknote counter according to claim 2, comprising:
a canceling unit for canceling a transaction in the middle of the transaction,
wherein the transmission unit transmits information on a transaction cancelled by the canceling unit to a higher-ranking machine.

4. The banknote counter according to claim 1, comprising a reporting unit for reporting that a suspected counterfeit banknote is recognized by the recognition unit.

5. The banknote counter according to claim 1, comprising:
a stacking unit for receiving and stacking banknotes each of which is recognized as a normal transaction banknote by the recognition unit and transported by the transport unit; and
a rejection unit for receiving and stacking banknotes each of which is not recognized as a normal transaction banknote such as a suspected counterfeit banknote by the recognition unit and transported by the transport unit,
wherein the control unit, when a suspected counterfeit banknote is recognized by the recognition unit, makes the display unit display which ordinal number of banknotes stacked in the rejection unit the suspected counterfeit banknote corresponds to.

6. The banknote counter according to claim 1, comprising:
a manual input unit for manually inputting information of a banknote to be included in one transaction,
wherein the control unit causes banknote information, which is manually input with the manual input unit, to be included as information which can be recognized as manually input information, as at least a part of the transaction information.

7. The banknote counter according to claim 6, comprising:
a manual input possibility decision unit for deciding whether manually inputting with the manual input unit is allowed,
wherein the control unit does not accept manually inputting with the manual input unit if the manual input possibility decision unit does not allow manual input.

8. The banknote counter according to claim 2, comprising:
a chip calculation unit for calculating an exchange content of chips exchangeable in accordance with a confirmed amount,
wherein the control unit causes the display unit to display a calculation result by the chip calculation unit and/or causes the transmission unit to transmit the calculation result to a higher-ranking machine.

9. A banknote counting system comprising:
the banknote counter according to claim 1; and
a sales management unit for communicating with the banknote counter and managing transaction information.

10. A banknote counting system comprising:
the banknote counter according to claim 1; and
a banknote counter management unit for communicating with the banknote counter and managing operation states of the banknote counter.

11. The banknote counting system according to claim 10, wherein at least an occurrence state of a suspected counterfeit banknote is contained in an operation state to be managed by the banknote counter management unit.

12. A banknote counting system comprising:
the banknote counter according to claim 1;
a terminal communicatively connected to the banknote counter; and
a sales management unit which communicates with the terminal and/or the banknote counter and manages transaction information.
